(19) United States
(12) Patent Application Publication
(10) Pub. No.: US 2016/0172666 A1
(43) Pub. Date: Jun. 16, 2016

(54) ELECTRODE STRUCTURE AND SECONDARY BATTERY

(71) Applicants: Tadahiro Ohmi, Sendai-shi (JP); Tetsuya Goto, Sendai-shi (JP); New Nippon Metal Mining Industry Co., Ltd., Tokyo (JP)

(72) Inventors: Kenzo Shimizu, Chiyoda-ku (JP); Tadahiro Ohmi, Sendai-shi (JP); Tetsuya Goto, Sendai-shi (JP)

(73) Assignees: New Nippon Metal Mining Industry Co., Ltd., Tokyo (JP); Tohoku University, Sendai-shi (JP)

(21) Appl. No.: 15/050,602

(22) Filed: Feb. 23, 2016

Related U.S. Application Data
(63) Continuation of application No. PCT/JP2013/005062, filed on Aug. 27, 2013.

(51) Int. Cl. H01M 4/36; H01M 10/0525

(52) U.S. Cl. CPC H01M 4/366; H01M 10/0525

(57) ABSTRACT

An electrode structure is provided. The electrode structure includes an electron donating region, an electrode withdrawing region different from the electron donating region, and a region configured to electrically isolate at least surfaces of the electron donating region and the electrode withdrawing region.

This application is a continuation of International Patent Application No. PCT/JP2013/005062 filed on Aug. 27, 2013, the entire content of which is incorporated herein by reference.

### TECHNICAL FIELD

The present invention relates to an electrode structure and a secondary battery.

### BACKGROUND ART

Renewable energy, especially facility construction for large-scale solar cells has recently received an attention from the viewpoints of resource problems and global environment problems such as global warming and ozone holes. However, in order to make the solar cells prevail globally, solar cell systems suitable for areas where quantities of solar radiation are small and the solar radiation times are short are required. For example, in Japan regions, the average quantity of solar radiation is 1 kW/m², and the power generation enable time is 3 hrs/day. Under these conditions, for the remaining time zone of a day, that is 21 hrs, power stored in a storage battery must be supplied. A storage battery having current performance is not practical because it becomes too large. In the fields of moving unit such as vehicles including hybrid vehicles and EVs, and self-power supply trains, and self-transporting work unit such as motor-driven forklifts, strong demands have arisen for implementing high-performance, environment-friendly storage batteries excellent in charging/discharging.

Meanwhile, the most promising storage battery in recent years is a lithium ion battery. In particular, a storage battery using iron lithium phosphate (LiFePO₃) as a positive electrode material is most promising (Japanese Patent No. 3484003). The conventional lithium cobalt oxide (LiCoO₂) emits a large amount of oxygen at a temperature of about 80° C. and may be subjected to abnormal heating (overheating), fracture and finally a fire accident. To the contrary, iron lithium phosphate does not emit oxygen and is said to be a safe positive electrode material.

### SUMMARY OF INVENTION

### Technical Problem

However, the conventional lithium ion battery electrode structure itself has a limitation to obtain a lithium ion storage battery having performance which satisfies the above needs.

One embodiment of the present invention provides an electrode structure capable of implementing a high-performance lithium ion battery having charging/discharging characteristics better than the conventional one, and a storage battery including the electrode structure.

It is another object of the present invention to provide an electrode structure having an electron donating function and an electron withdrawing function.

It is still another object of the present invention to provide an electrode structure suitable for implementing a secondary battery capable of having a large storage amount in a small size and capable of rapid charging, and a secondary battery including the electrode structure.

### Solution to Problem

One method for solving the above problems according to the present invention is an electrode structure comprising an electron donating region surface, an electron withdrawing region surface different from the electron donating region surface, and a region configured to electrically separate the electron donating region surface and the electron withdrawing region surface.

Another method for solving the above problems according to the present invention is an electrode structure comprising an electron donating region, an electron withdrawing region different from the electron donating region, and a region configured to electrically separate at least surfaces of the electron donating region and the electron withdrawing region.

Still another method for solving the above problems according to the present invention is a storage battery comprising at least one pair of electrode structures each including an electron donating region surface, an electron withdrawing region surface different from the electron donating region surface, and a region configured to electrically separate the electron donating region surface and the electron withdrawing region surface, a separator arranged between the pair of electrode structures, and an electrolyte stored in a gap sandwiched between the pair of electrode structures.

Still another method for solving the above problems according to the present invention is a storage battery comprising at least one pair of electrode structures each including an electron donating region surface, an electron withdrawing region surface different from the electron donating region surface, and a region configured to electrically separate the electron donating region surface and the electron withdrawing region surface, a separator arranged between the pair of electrode structures, and a gap sandwiched between the pair of electrode structure and configured to store an electrolyte.

Still another method for solving the above problems according to the present invention is a storage battery comprising at least one pair of electrode structures each including an electron donating region surface, an electron withdrawing region surface different from the electron donating region surface, and a region configured to electrically separate both sides of the electron donating region surface and the electron withdrawing region surface, a separator arranged between the pair of electrode structures, and a gap sandwiched between the pair of electrode structures and configured to store an electrolyte, wherein a plurality of the pairs of electrode structures are stacked on each other.

### Advantageous Effects of Invention

By employing the electrode structure of the present invention, a high-performance lithium ion battery having charging/discharging characteristics better than the conventional one can be implemented. In addition, there is also implemented a secondary battery capable of having a large storage amount in a small size and capable of rapid charging.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate exemplary embodiments of the invention and, together with the description, serve to explain the principles of the present invention.

FIG. 1 is a schematic view for explaining the typical example of the main part of a battery cell structure according to the present invention;

FIG. 2 is a schematic view for explaining a structure of an electrode structure according to the present invention;

FIG. 3 is a schematic view for explaining the layout of the surface of an upper stage portion of a collector of the electrode structure shown in FIG. 2;

FIG. 4 is a schematic view for explaining the structure of another electrode structure according to the present invention; and

FIG. 5 is a schematic view for explaining a structure of a storage battery according to the present invention.

### DESCRIPTION OF EMBODIMENTS

The present invention will be described in detail below with reference to the accompanying drawings. The present invention is not necessarily limited by the contents to be described below. Contents which can solve the problems of the present invention are incorporated in the category of the present invention.

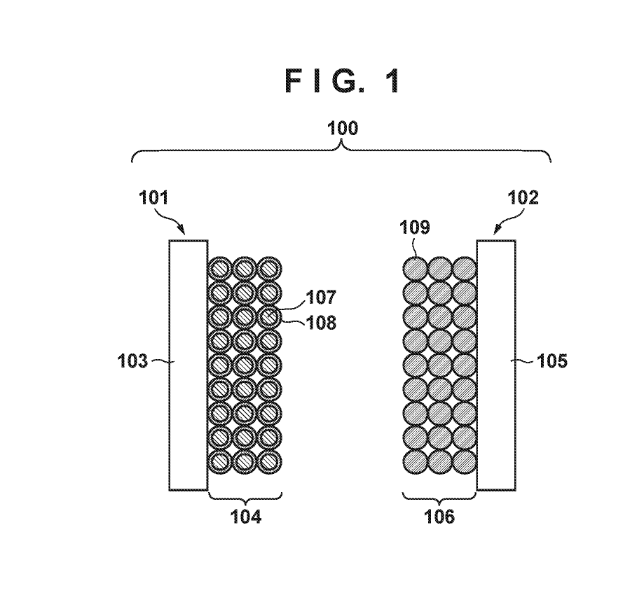

FIG. 1 is a schematic view for explaining a typical example of a main part 100 of the structure of a lithium ion battery (secondary battery or storage battery). Referring to FIG. 1, the main part 100 of the battery cell structure basically includes a positive electrode 101, a negative electrode 102, a separator (not shown) arranged therebetween, and an electrolyte (not shown) impregnated in the separator. That is, the lithium ion battery according to the present invention comprises three layers, that is, the positive electrode 101, the separator (not shown), and the negative electrode 102. The resultant structure is covered with the electrolyte (battery main part 100).

The electrochemical reaction in the lithium ion battery can be explained using the positive electrode, the negative electrode, and the electrolyte. Each of the positive electrode and the negative electrode can receive lithium ions (Li⁺) into its constituent member. Movement of lithium (Li) to the positive electrode and the negative electrode is called insertion or intercalation. To the contrary, movement of lithium from the positive electrode and the negative electrode is called extraction or de-intercalation.

In the battery, lithium moves from the positive electrode to the negative electrode during charging. During discharging, lithium moves from the negative electrode to the positive electrode. Note that in a secondary battery including a lithium ion battery, generally, an anode reaction (oxidation reaction) progresses in the positive electrode during charging. The discharging state (during battery operation) is given as a reference, so that generally the positive electrode is called a cathode, and the negative electrode is called anode. According to the present invention as well, the positive and negative electrode are called the cathode and anode, unless otherwise specified.

In a typical lithium ion battery according to the present invention, a lithium metal oxide is used as an active material of the positive electrode. An aluminum foil is used as a collector 103 of the positive electrode. A carbon material is used as the active material of the negative electrode. A copper foil is used for a collector 105 of the negative electrode. A microporous film of a polyolefin is used as the separator. A solution obtained by dissolving a lithium salt in a carbonate-based organic solvent is used as the electrolyte. Polyvinylidene fluoride (PVDF), styrene butadiene rubber (SBR), or the like is used as the binder (binding agent) of the active material. Activated carbon, graphite fine powder, a carbon fiber, or the like is used as a conductive aid.

Referring to FIG. 1, the main part 100 of the battery cell structure basically includes the positive electrode 101, the negative electrode 102, the separator (not shown) arranged therebetween, and the electrolyte (not shown) impregnated in the separator. For example, the positive electrode 101 includes the aluminum (Al) collector 103 and a positive electrode active material layer 104 formed on the surface of the collector 103 and mainly containing iron lithium phosphate particles 107. The negative electrode 102 includes the copper (Cu) collector 105 and a negative electrode active material layer 106 formed on the surface of the collector 105 and mainly containing carbon (C) particles 109. Each iron lithium phosphate particle 107 is covered with a conductive coating layer 108 made of a conductive material such as carbon to lower the surface electrical resistance.

In this case, the chemical reactions during charging and discharging in the battery are as follows.

(1) During Charging

When a positive voltage is applied to the collector 103 and a negative voltage is applied to the collector 105, respectively, electrons are withdrawn from the positive electrode 101 to emit lithium ions (Li⁺). The negative electrode 102 donates electrons (e⁻) to the emitted lithium ions (Li⁺).

The following reactions occur to charge the battery cell. That is, the following chemical reaction occurs in the positive electrode 101:

LiFePO₄→Li₁₋ₓFePo₄+xLi⁺+xe⁻ (A)

(x: positive integer)

(the coefficient “x” is used to indicate so as to describe the formula in mol.)

The following chemical reaction occurs in the negative electrode 102:

6C+Li⁺+e⁻→C₆Li (B)

(e⁻:electron)

(2) During Discharging (During Battery Operation)

Electrons are extracted from C₆Li in the negative electrode 102 to generate lithium ions (Li⁺). The lithium ions (Li⁺) move toward the positive electrode 101. The positive electrode 101 donates electrons to the moved lithium ions (Li⁺), thereby producing LiFePO₄. That is, the reversible reaction of formula A occurs in the positive electrode 101, and the reversible reaction of formula B occurs in the negative electrode 102.

If the positive electrode active material layer 104 is made of lithium cobalt oxide (LiCoO₂), the following reactions occur in the respective electrodes.

The reaction in the positive electrode 101 is as follows:

LiCoO₂ [symbol] Li₁₋ₓCoO₂+xLi⁺+xe⁻ (C)

The reaction in the negative electrode 102 is as follows:

xLi⁺+xe⁻+6C [symbol] LiₓC₆ (D)

(x: positive integer)

The overall reaction has the following limitation. That is, lithium cobalt oxide (LiCoO₂) is oversaturated by excessive discharge to cause the following reaction to result in production of lithium oxide:

Li⁺+LiCoO₂→Li₂O+CoO

It is reported that X-ray analysis has confirmed in accordance with the following reaction that the cobalt (IV) oxide is produced by excessively charging the lithium cobalt oxide to 5.2 V or higher:

LiCoO₂→Li⁺+CoO₂

In the lithium ion battery, the lithium ions (Li⁺) are carried to the negative and positive electrodes and reduced into a metal. On the other hand, cobalt in LiₓCoO₂ is oxidized from Co³⁺ to Co⁴⁺ by charging and reduced from Co⁴⁺ to Co³⁺ by discharging.

Examples of the positive electrode active material employed in the present invention are a layered oxide, spinel, phosphate (olivine), transition metal oxide, sulfide, and chalcogenide (selenium or tellunium). The practical example of the positive electrode active material can be selected from the following materials, as needed, in addition to lithium cobalt oxide (LiCoO₂) and iron lithium phosphate (LiFePO₃).

lithium manganese oxide (LiMn₂O₄)

lithium nickel oxide (LiNiO₂)

lithium iron fluorophosphate (Li₂FePO₄F)

cobalt.nickel.lithium manganese oxide (LiCo_{1/3}Ni_{1/3}Mn_{1/3}O₂)

lithium.nickel.manganese.lithium cobalt oxide (Li(LiₐNiₓMn_{y}Co_{z})O₂)

Since 70% of the cost of the lithium ion secondary battery is cobalt as a rare metal element used in the positive electrode active material (positive electrode material), a material which uses manganese, nickel, and iron phosphate has been developed to greatly reduce the cost. Iron lithium phosphate (LiFePO₃) is suitably used from the viewpoints of performance and stability of an assembled battery, easiness of an assembly process, reliability cost, safety, and operating experience.

The generated average voltage (V), the unit capacity (mA·h/g), and the generated unit energy (kW·h/kg) in use of the above-mentioned positive electrode active material (positive electrode material) are summarized in Table 1 below.

TABLE 1

| Positive | Average | Capacity per | Energy per |
|---|---|---|---|
| Electrode | Voltage | Weight | Weight |
| Material | (V) | (mA · h/g) | (kW · h/kg) |
| LiCoO₂ | 3.7 | 140 | 0.518 |
| LiMn₂O₄ | 4.0 | 100 | 0.400 |
| LiNiO₂ | 3.5 | 180 | 0.630 |
| LiFePO₄ | 3.3 | 150 | 0.495 |
| Li₂FePO₄F | 3.6 | 115 | 0.414 |
| LiCo_{1/3}Ni_{1/3}Mn_{1/3}O₂ | 3.6 | 160 | 0.576 |
| Li(LiₐNiₓMn_{y}Co_{z})O₂ | 4.2 | 220 | 0.920 |

The positive electrode active material is prepared in the form of particles, as exemplified in FIG. 1. Alternatively, the positive electrode active material is prepared in the form of powder, fiber, needle, or chip. The positive electrode material is kneaded together with a binding agent, as needed, and coated to the collector 103. For example, in addition to the positive electrode active material, a binder such as PVDF, and a conductive aid such as carbon black, a graphite fine powder, or a carbon fiber are kneaded in N-methylpyrrolidone (NMP) to prepare a paste, and the paste was coated to an aluminum foil collector to obtain a positive electrode.

As shown in FIG. 1, the positive electrode active material is prepared in the form of a sphere. The surface of each particle is not limited to the sphere, but can be in a convex/concave shape or need-like shape. In order to increase the unit capacity, the interior and surface of each particle may be porous. If the positive electrode active material is used in a particle-like shape, the surface of each particle may be coated with a material having a high conductivity such as carbon (formation of the coating layer) to lower its electrical resistance, as needed. The coating layer may be porous with an appropriate gap size so as to efficiently permeate the lithium ions (Li⁺) of the internal positive electrode active material. That is, the gap size is set to be larger than the size of each of the lithium ions (Li⁺).

Furthermore, the positive electrode active material, the binding agent, and as needed the solvent are kneaded to prepare a kneaded composition. This composition is coated to the collector 103 to form the positive electrode active material layer 104. When the solvent is evaporated from the positive electrode active material layer 104, a number of gaps are formed in a net-like shape in the positive electrode active material layer 104, thereby greatly improving the generation efficiency of the lithium ions (Li⁺) at the time of charging and hence increasing the unit capacity. In this case, the gap size may be larger than that of each of the lithium ions (Li⁺).

A material which does not substantially prevent the effect of the present invention can be used as the negative electrode active material employed in the present invention. One of the main negative electrode active materials employed in the present invention is a carbon material. The carbon material may be used as the negative electrode active material because it is a highly stable and has a long cycle lifetime. The negative electrode carbon materials are classified into a highly crystalline graphite system in which carbon atom graphene planes are stacked and a hard carbon system in which the crystal orientation is random and does not have regularity. The development of various types of carbon materials greatly improves the battery performance such as a decrease in reversible capacity and improvement of cycle characteristics. In recent years, new carbon materials such as a carbon nanotube and fullerene and new negative electrode active material except carbon materials, such as a tin compound or a composite material of silicon and carbon have been developed.

The discharge characteristics of graphite and hard carbon are known to have different features. Graphite performs the discharge operation with an almost flat voltage from the initial stage to the final stage of the discharge and the voltage is abruptly decreased at the end of final stage of the discharge, while hard carbon performs the discharge operation for uniformly decreasing the voltage until the discharge end voltage. For this reason, by measuring the voltage of hard carbon, the capacity of the battery can be accurately known. Since the voltage change of graphite is small, the voltage can be relatively stable until the final stage of the discharge and can maintain a high voltage. Since hard carbon has an excellent cycle characteristic exceeding 1,000 cycles, it may be used in the present invention.

In addition, lithium titanate (LTO) is also highly safe and excellent in low-temperature characteristics. Lithium titanate can have a charging/discharging cycle of about 6,000 cycles or more and may be used in the present invention.

In addition, according to the present invention, a carbon material such as a carbon nanotube or fullerene, a tin compound, and a composite material of silicon and carbon can be used for application purposes, as needed. If silicon particles are used as the negative electrode active material, n⁺-type Si particles doped with phosphorus (P) or arsenic (As) to about 8×10¹⁹ to 7×10²⁰ cm⁻³ to decrease the electrical resistance may be employed. With this arrangement, the electrical resistance of the silicon particles can be reduced, and the current extraction amount can be increased. In addition, the negative electrode active material layer may crack due to the repetition of volume expansion/contraction at the time of charging/discharging. This can be prevented by employing porous silicon particles to increase the effective surface area.

In addition to the negative electrode active material, a binder such as PVDF or SBR is kneaded in a solvent such as NMP or water to prepare a paste (a conductive aid such as carbon black may be added as in the positive electrode). The paste is coated to a copper foil collector to form the negative electrode 102.

The generated average voltage (V), the unit capacity (mA·h/g), and the generated unit energy (kW·h/kg) of some of the above-mentioned negative electrode active materials (negative electrode material) are summarized in Table 2 below.

TABLE 2

| Negative | Average | Capacity per | Energy per |
|---|---|---|---|
| Electrode | Voltage | Weight | Weight |
| Material | (V) | (mA · h/g) | (kW · h/kg) |
| graphite (LiC₆) | 0.1-0.2 | 372 | 0.0372- |
| | | | 0.0744 |
| titanate (Li₄Ti₅O₁₂) | 1-2 | 160 | 0.16-0.32 |
| Si (Li_{4.4}Si) | 0.5-1 | 4212 | 2.106-4.212 |
| Ge (Li_{4.4}Ge) | 0.7-1.2 | 1624 | 1.137-1.949 |

The electrolyte used in the present invention is a non-aqueous solution-based electrolyte because an aqueous solution-based electrolyte is subjected to electrolysis by lithium. The electrolyte of the lithium ion battery is obtained by dissolving a supporting electrolyte such as lithium hexafluorophosphate (LiPF₆) or lithium tetrafluoroborate (LiBF₄) in an organic solvent such as a cyclic carbonate such as ethylene carbonate (EC) or propylene carbonate (PC) or a chain carbonate such as dimethyl carbonate or diethyl carbonate. Alternatively, a lithium gel polymer electrolyte obtained by using a non-fluidized liquid can be used. An example of the liquid gel polymer electrolyte is a gel polymer electrolyte gelled by adding an organic solvent to a polymer compound such as polyethylene oxide (PE) or polyvinylidene fluoride. In addition, according to the present invention, an intrinsic polymer electrolyte such as polyether having ion conductivity can be used.

According to the present invention, the separator is configured to be sandwiched between the positive electrode and the negative electrode of the battery. The function of the separator is to prevent a short-circuit caused by the contact of the positive and negative electrodes and to hold the electrolyte to ensure the ion conductivity. According to the present invention, a film-like microporous film may be used as the separator in order to ensure the mobility of the lithium ions (Li⁺). A polyolefin such as polyethylene or polypropylene can be used as a separator material. The separator may be thinned as much as possible in order to increase the amount of electrode material filled in the battery. The separator has a so-called “shutdown” function for clogging pores with polyolefin melted upon the rise of the temperature inside the battery. The separator also plays a role as a failsafe unit of the lithium ion battery.

The liquid electrolyte used in the present invention may be made of a solvent such as ethylene carbonate and a lithium salt such as LiPF₆, LiBF₄, or LiClO₄. The liquid electrolyte is filled between the positive electrode and the negative electrode, and the lithium ions move by charging/discharging. Generally, the conductivity of the electrolyte at room temperature (20° C.) is 10 mS/cm (1 S/m), 30% to 40% at 40° C., and further decreased at about 0° C. The use environment temperature is about 10° C. above and below the room temperature (20° C.).

For example, the battery is manufactured as follows. An active material solution of lithium cobalt oxide or the like is coated to the both sides of, for example, an aluminum foil and dried. After that, the resultant structure is pressed to increase the density, thereby forming the positive electrode 101. A solution of a carbon material is coated to a copper foil and dried. The resultant structure is pressed to increase the density, thereby forming the negative electrode 102. An electrode material is intermittently coated, in a lateral stripe shape, to an electrode foil manufactured in a long band-like shape, and the electrode foil is cut in accordance with the shape and size of a battery serving as a product. Portions to which the electrode material is not coated serve as portions to which connection terminals (tabs) for inputting/outputting power are welded. An aluminum tab is used for the positive electrode, while a nickel tab is used for the negative electrode.

A porous insulating film (separator) capable of moving ions is sandwiched between the positive electrode 101 and the negative electrode 102. The resultant structure is wound like baumkuchen such that the positive electrode 101, the negative electrode 102, and the insulating film are stacked in a multilayered structure. If a battery shape is cylindrical, the electrodes 101 and 102 are would in a cylindrical shape, and the resultant structure is nickel-plated and stored in an iron can. The negative electrode 102 is welded on the bottom of the can, and an electrolyte is poured into the can. After that, the positive electrode 101 is welded to a lid (top cap). The resultant structure is sealed by a pressing machine like a canned food product. If a battery is a square type battery, the electrodes 101 and 102 are wound flat so as to conform to the shape of the can, and the positive electrode 101 is welded to the aluminum outer can. In the case of the square type battery, the battery can be sealed by laser welding.

The lithium ion battery has a normal region and a dangerous region which are close to each other. For this reason, a protection circuit for monitoring charging/discharging is arranged to ensure safety. When a voltage rises at the time of charging, the positive electrode and the negative electrode are set in extremely strong oxidizing/reducing state. The materials of the lithium ion battery become unstable as compared with other low-voltage batteries. When the lithium ion battery is excessively charged, the positive electrode side is heated due to oxidation of the electrolytic solution and the destruction of the crystal structure. On the negative electrode side, metal lithium is deposited. This phenomenon not only abruptly degrades the battery, but also causes rupture and a fire in the worst case. Voltage control at very high precision (several 10 mV level) at the time of charging can solve this problem.

If excessive discharge occurs, cobalt (Co) of the positive electrode or copper of the negative electrode is eluted. The lithium ion battery does not function as the secondary battery. In some cases, the battery is abnormally heated. Therefore, excessive discharge is utmost undesirable. For this reason, an excessive discharge prevention circuit is desirably arranged.

Since the lithium ion battery has a characteristic of a high energy density, danger of abruptly overheating the battery in the case of a short-circuit may be possible, the electrolytic solution of the organic solvent may be evaporated, and a fire accident may occur. For these reasons, a short-circuit prevention countermeasure is desirably taken. In addition, a short-circuit may occur inside the battery by applying an external force to the battery. A protection countermeasure against the shock is desirably taken. More specifically, a safety valve with a current cutoff function is incorporated to prevent a case in which the temperature rises due to an internal short-circuit to increase the internal pressure. This safety valve is disposed, for example, on the convex portion of the positive electrode. When the safety valve is opened, a gas is emitted outside when a pressure of a predetermined value or more is applied to the battery. In addition, a cylindrical battery top cover is designed to have a structure in which a PTC element whose internal resistant increases with an increase in temperature is incorporated, and a current is electrically cut off upon an increase in temperature.

In addition to the above countermeasures, it is desirable to provide the following safety measures.

(1) A stainless steel pin is provided at the center of a battery element to increase the strength against bending of the can.
(2) An insulating tape is adhered to an electrode tab itself or a tab mounting portion to prevent an internal short-circuit from the tab edge.
(3) An insulating tape is adhered to the winding start portion and the winding end portion of the electrode to prevent generation of a dendrite (dendrite formation may be caused by deposition of not only lithium metal but also zinc as an impurity contained in an aluminum foil or the like).
(4) A fine ceramic powder is applied to part or almost all the area of the electrode or separator to increase the strength of the insulating layer.

As can be understood from the above description, the positive electrode and the negative electrode must have the electron donating function and the electron withdrawing function. According to the present invention, these two functions can be greatly improved as compared with the conventional secondary battery cell.

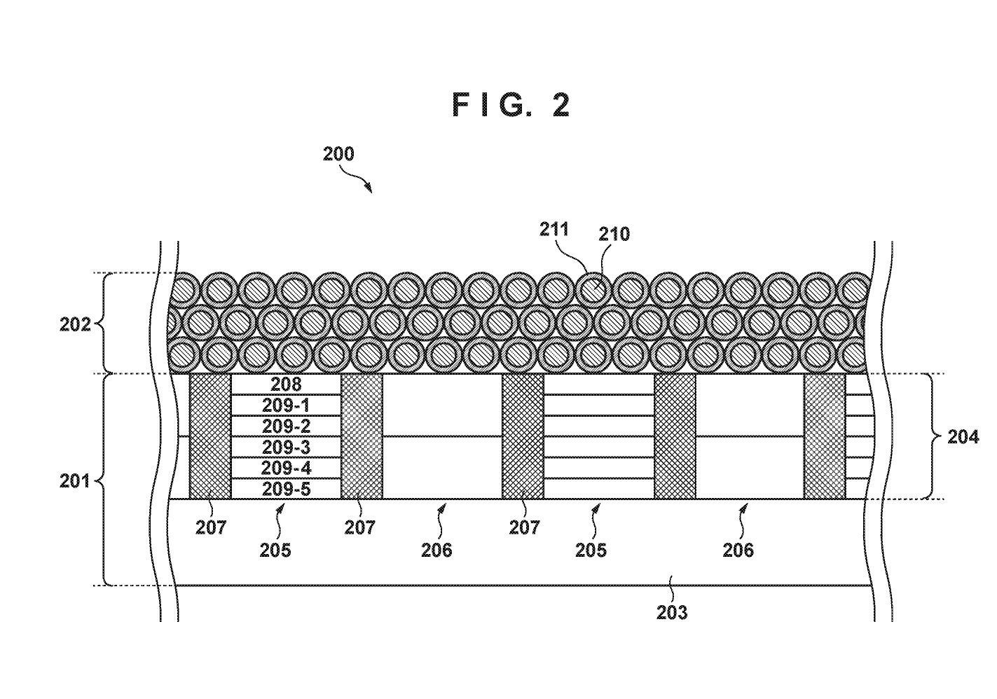

FIG. 2 shows one example of the electrode structure according to the present invention. The electrode structure shown in FIG. 2 is an example of a positive electrode 200. The positive electrode 200 shown in FIG. 2 includes, as an electrode structure, a collector 201 and a positive electrode active material layer 202. For example, the positive electrode active material layer 202 is a coating layer mainly containing LiFePO₄ particles 211 each having a surface coated with a conductive coating layer 210 made of carbon or the like, as shown in FIG. 1. The LiFePO₄ particles are kneaded with an appropriate binder and coated on the collector 201.

The collector 201 includes a lower stage portion 203 and an upper stage portion 204. The lower stage portion 203 has a current collection function and is made of a metal such as aluminum (Al). The upper stage portion 204 includes electron donating regions 205 and electron withdrawing regions 206. The electron donating regions 205 and the electron withdrawing regions 206 may be adjacent to each other or isolated from each other. They may be electrically isolated from each other, as shown in FIG. 2.

Isolation regions 207 may be simple grooves or made of an electrical insulating material. From the viewpoint of an increase in mechanical strength and improvement of electrical insulation reliability of the upper stage portion 204, the isolation regions 207 may be formed by embedding the electrically insulating material in the grooves. The isolation regions 207 are formed in the upper stage portion 204 in the entire thickness direction in FIG. 2. However, the isolation regions 207 may be formed to an appropriate thickness in a surface layer portion (on the side of the positive electrode active material layer 202) of the upper stage portion 204.

As can be understood from the description using the chemical reaction formulas, the positive and negative electrodes of the lithium ion battery need to alternatively have the electron injection (donating) function and the electron withdrawing function. A material excellent in the electron donating force (electron injection function) is employed as the material forming the electron donating regions 205. An example of the material excellent in the electron injection function is a material having a low work function (low work function material).

As the low work function material used in the present invention, a low work function material of 3 eV or less is desirably selected. Practical examples of the low work function material used in the present invention are barium (Ba), LaB₆, CeB₆, W—Cs, W—Ba, W—O—Cs, W—O—Ba, a 12CaO.7Al₂O₃(C12A7) electride, or the like. In particular, LaB₆ containing N (nitrogen) may be used because it is chemically stable. In particular, LaB₆ (2.4 eV) added with nitrogen of about 0.4% may be used.

The electron donating regions 205 may be made of the same material. However, an uppermost layer 208 directly electrically contacting the positive electrode active material layer 1 of the electron donating regions 205 may be made of a low work function material, and transition layers made of metal materials having work functions close stepwise to the work function of the metal material of the lower stage portion 203 may be interposed between the uppermost layer 208 and the lower stage portion 203.

FIG. 2 exemplifies a case in which five transition layers 209 are formed. Assume that the uppermost layer 208 is made of LaB₆ (2.4 eV) added with N (nitrogen) and the lower stage portion 203 is made of aluminum (Al) (4.28 eV). In this case, as an example, the following five transition layers 209 may be given. That is, from the side of the uppermost layer 208, an Sm or Pr (2.7 eV) layer (first transition layer (209-1)), an Er (3.1 eV) layer (second transition layer (209-2)), an La (3.5 eV) layer (third transition layer (209-3)), an Hf (3.8 eV) layer (fourth transition layer (209-4)), and a Zr (4.1 eV) layer (fifth transition layer (209-5)) form a five-layer structure.

A decrease in resistance of a current path in the battery as much as possible can improve the current extraction efficiency. The above example exemplifies a case in which the lower stage portion 203 of the collector 201 is made of an aluminum (Al) foil. Aluminum (Al) is readily oxidizable. The surface of the aluminum (Al) foil tends to be oxidized to form an Al₂O₃film, thereby increasing the resistance. From this viewpoint, the lower stage portion 403 may be made of a copper (Cu) foil because the above oxidation hardly occurs.

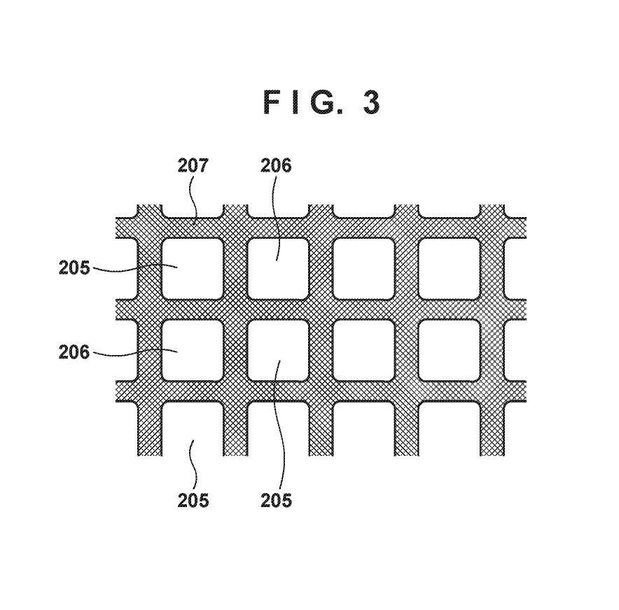

FIG. 3 shows the layout of the surface of the upper stage portion 204 of the collector 201. Referring to FIG. 3, in at least the surface layer portion of the upper stage portion 204, the electron donating regions 205 and the electron withdrawing regions 305 are isolated from each other by the isolation regions 207. The electron donating regions 205 and the electron withdrawing regions 206 are alternately arranged in an island form having an almost square surface shape. The size of the island is determined in accordance with the application purpose, as needed, and may be 0.5 μm to 10 μm square. The width of each of the isolation regions 207 is also selected in accordance with the application purpose, as needed, and may be 0.2 μm to 0.5 μm.

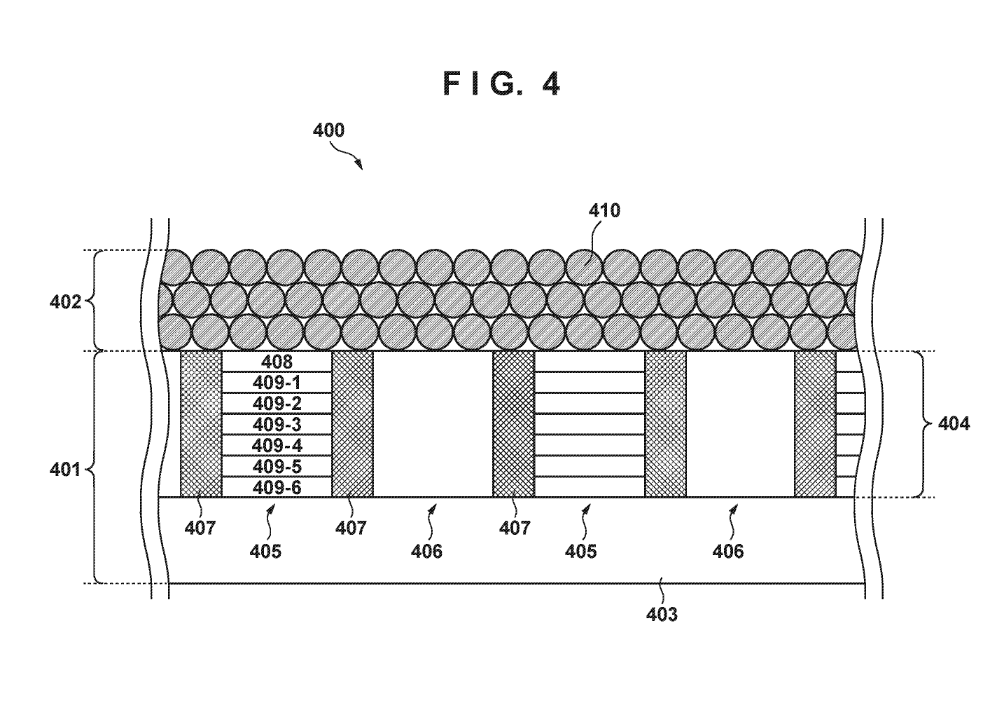

FIG. 4 shows another example of an electrode structure according to the present invention. The electrode structure shown in FIG. 4 is an example of a negative electrode 400. The negative electrode 400 shown in FIG. 4 includes, as an electrode structure, a collector 401 and a negative electrode active material layer 402. For example, the negative electrode active material layer 402 is a coating layer mainly containing carbon particles 410, as shown in FIG. 1. The carbon particles are kneaded with an appropriate binder and coated on the collector 401.

The collector 401 includes a lower stage portion 403 and an upper stage portion 404 as in the collector 201. The lower stage portion 403 has a current collection function and is made of a metal such as copper (Cu). The upper stage portion 404 includes electron donating regions 405 and electron withdrawing regions 406. The electron donating regions 405 and the electron withdrawing regions 406 may be adjacent to each other or insulated from each other. They may be electrically isolated, as shown in FIG. 4.

In the collector 401, each electron donating region 405 has a seven-layer structure, and each electron withdrawing region 406 has a single-layer structure unlike the collector 201. An uppermost layer 408 of each electron donating region 405 has the same function as that of the uppermost layer 208 and is made of the same material as that of the uppermost layer 208.

FIG. 4 exemplifies a case in which six transition layers 409 are formed. Assume that the uppermost layer 408 is made of LaB₆ (2.4 eV) added with N (nitrogen) and the lower stage portion 403 is made of copper (Cu) (4.6 eV). In this case, as an example, the following six transition layers 409 may be given. That is, from the side of the uppermost layer 408, an Sm or Pr (2.7 eV) layer (first transition layer (409-1)), an Er (3.1 eV) layer (second transition layer (409-2)), an La (3.5 eV) layer (third transition layer (409-3)), an Hf (3.8 eV) layer (fourth transition layer (409-4)), a Zr (4.1 eV) layer (fifth transition layer (409-5)), and an Al (4.3 eV) layer (sixth transition layer (409-6)) form a six-layer structure.

Next, an example of a method of manufacturing a collector including electron donating regions and electron withdrawing regions will be described in detail below.

Positive electrode active material layer formation composition (A)

. . . LiFePO₄:acetylene black:polyvinylidene fluoride=91:4:5

Negative electrode active material layer formation composition (B)

. . . carbon particles:acetylene black:polyvinylidene fluoride=93:2:5

Electrolytic solution (C)
. . . electrolyte material/LiPF₆

solvent/ethylene carbonate:ethyl methyl carbonate=30:70

A high-temperature heat-resistant plastic material (available from Zeon Corporation) having a predetermined thickness is coated to a copper foil serving as the lower stage portion of the collector by a slit coater. The resultant structure is prebaked at 90° C. in the atmosphere (120 sec) and exposed with a g-, h-, or i-ray.

Portions serving as the electron withdrawing regions are exposed, and the resultant structure is developed at room temperature using a 0.4% TMAH solution (about 70 sec). An Ni layer is formed in holes of the collector of the Cu-foil lower stage portion by electroplating, thereby forming the electron withdrawing regions.

Next, portions serving as the electron donating regions are patterned. Al, Zr, Hf, La, Er, Sm/Pr, and nitrogen-added LaB₆ are continuously formed by a rotary magnet sputtering apparatus proposed by the present inventor.

After film formation, the resultant structure is sintered in an N₂ atmosphere at 230° C. for about 60 min, thereby manufacturing a negative electrode collector including the electron donating regions and the electron withdrawing regions.

The positive electrode material layer formation composition (A) is coated to the resultant structure to form the positive electrode active material layer, thereby forming the positive and negative electrodes.

If a collector includes an Al-foil lower stage portion, a Cu layer and an Ni layer are formed by electroplating in this order, thereby forming the electron withdrawing regions.

Next, portions serving as the electron donating regions are patterned. Zr, Hf, La, Er, Sm/Pr, and nitrogen-added LaB₆ are continuously formed by the rotary magnet sputtering apparatus proposed by the present inventor.

After film formation, the resultant structure is sintered in an N₂ atmosphere at 230° C. for about 60 min, thereby manufacturing a positive electrode collector including the electron donating regions and the electron withdrawing regions.

The negative electrode material layer formation composition (B) mainly containing carbon particles is applied to the resultant structure to form the negative electrode active material layer, thereby forming the negative electrode. In this case, a Cu foil may be used in place of the Al foil.

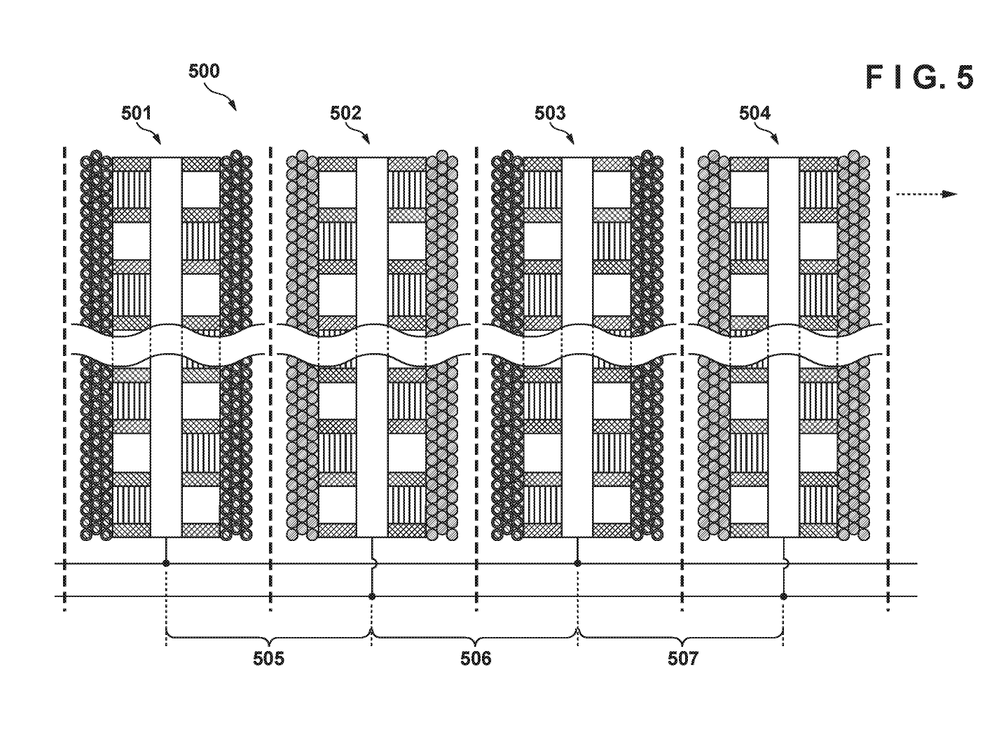

An example for actually manufacturing an Li ion battery will be described with reference to FIG. 5. FIG. 5 is a schematic view for explaining a stacked battery in which electrodes each having both sides with the positive or negative active material layer are alternately arranged in an order of “positive, negative, positive, negative . . . ”

When manufacturing a stacked battery 500, for example, a Cu collector lower stage portion sheet (size: 150 mm×100 mm×15 μm thick) for the positive electrode and a Cu collector lower stage portion sheet (size: 150 mm×100 mm×15 μm thick) for the negative electrode are prepared.

The electron withdrawing regions (Ni layers) and the electron donating regions (a seven-layer structure of nitrogen-added LaB₆, Sm/Pr, Er, La, Hf, Zr, and Al) are alternately formed in a matrix form on the both sides of the sheets. The positive electrode active material formation composition (A) with carbon coating is coated to the surface of the sheet for the positive electrode to form the positive electrode active material layer, thereby obtaining a two-surface positive electrode 501. The negative electrode active material formation composition (B) with carbon coating is coated to the surface of the sheet for the negative electrode to form the negative electrode active material layer, thereby obtaining a two-surface negative electrode 502.

The positive electrode 501 and the negative electrode 502 which are thus manufactured are stacked so as to sandwich a separator (not shown) impregnated with the electrolytic solution (C), thereby forming the stacked battery 500. Predetermined numbers of battery cells 505, 506, and 507 are stacked, as needed, in the stacked battery 500. A predetermined number of these battery cells are electrically connected in series or parallel. This makes it possible to arbitrarily extract a current or voltage having a desired value.

According to the present invention, out of various metals described above, for example, as a substituent metal, Sc (−3.5 eV) can be used in place of La (−3.5 eV), and Y, Ce, Tb or Ho (−3.1 eV each) can be used in place of Er (−3.2 eV)

As has been described above, when the electrode structure of the present invention is employed, the electron injection (donating) function and the electron withdrawing function can be greatly improved, and a large current can flow. The electrode structure of the present invention is not limited to a so-called lithium ion secondary battery, but is applicable to a lithium ion polymer secondary battery, a nanowire battery, and the like. A battery employing the electrode structure of the present invention is a lightweight storage battery having a high operating voltage and a large capacity, so that the compactness and lightweight arrangement of various types of portable devices can be greatly improved. In addition, the battery employing the electrode structure of the present invention is a most promising battery as an automobile storage battery of a hybrid vehicle, an electric vehicle, or the like and a power storage battery combined with a new energy system such as a solar cell or wind power generation.

The present invention is not limited to the above-described embodiments, and various changes and modifications can be made within the spirit and scope of the present invention. Therefore, to apprise the public of the scope of the present invention, the following claims are made.

### REFERENCE SIGNS LIST

100 . . . main part of battery
101 . . . positive electrode
102 . . . negative electrode
103, 105 . . . collector
104 . . . positive electrode active material layer
106 . . . negative electrode active material layer
107 . . . iron lithium phosphate particle
108 . . . conductive coating layer
200 . . . positive electrode
201, 401 . . . collector (electrode structure)
202 . . . positive electrode active material layer
203, 403 . . . lower stage portion
204, 404 . . . upper stage portion
205, 405 . . . electron donating region
206, 406 . . . electron withdrawing region
207, 407 . . . isolation region
208, 408 . . . uppermost layer
209, 409 . . . transition layer
210 . . . conductive coating layer
211 . . . LiFePO₄ particles
400 . . . negative electrode
402 . . . negative electrode active material layer
410 . . . carbon particle
500 . . . stacked battery
501, 503 . . . both sides positive electrode
502, 504 . . . both sides negative electrode
505, 506, 507 . . . battery cell

1. An electrode structure comprising an electron donating region, an electron withdrawing region different from the electron donating region, and a region configured to electrically separate at least surfaces of the electron donating region and the electron withdrawing region.

2. An electrode structure comprising an electron donating region, an electron withdrawing region different from the electron donating region, and a region configured to electrically separate at least surfaces of both sides of the electron donating region and the electron withdrawing region.

3. A storage battery comprising at least one pair of electrode structures each including an electron donating region surface, an electron withdrawing region surface different from the electron donating region surface, and a region configured to electrically separate the electron donating region surface and the electron withdrawing region surface, a separator arranged between the pair of electrode structures, and a gap sandwiched between the pair of electrode structure and configured to store an electrolyte.

4. A storage battery comprising at least one pair of electrode structures each including an electron donating region surface, an electron withdrawing region surface different from the electron donating region surface, and a region configured to electrically separate the electron donating region surface and the electron withdrawing region surface, a separator arranged between the pair of electrode structures, and an electrolyte stored in a gap sandwiched between the pair of electrode structures.

5. A storage battery comprising at least one pair of electrode structures each including an electron donating region surface, an electron withdrawing region surface different from the electron donating region surface, and a region configured to electrically separate both sides of the electron donating region surface and the electron withdrawing region surface, a separator arranged between the pair of electrode structures, and a gap sandwiched between the pair of electrode structures and configured to store an electrolyte, wherein a plurality of the pairs of electrode structures are stacked on each other.
